(19) United States
(12) Patent Application Publication
(10) Pub. No.: US 2008/0302879 A1
(43) Pub. Date: Dec. 11, 2008

(54) Heating Device

(75) Inventor: Lars Malmrup, Lund (SE)

Correspondence Address: MERCHANT & GOULD PC, P.O. BOX 2903, MINNEAPOLIS, MN, 55402-0903, US

(73) Assignee: Compower AB, Lund (SE)

(21) Appl. No.: 11/795,446

(22) PCT Filed: Jan. 27, 2006
(86) PCT No.: PCT/SE2006/000131

§ 371 Date: May 27, 2008

(30) Foreign Application Priority Data
Jan. 28, 2005 (SE) 0500222-5
Mar. 24, 2005 (ES) 0500667-1

(51) Int. Cl. F02C 1/04

(52) U.S. Cl. 237/12.1

(57) ABSTRACT

The present invention relates to a heating device for generating heat and electricity, and it comprises a compressor, at least one heat exchanger for heating air of a working flow leaving the compressor, a turbine where the heated air of the working flow is expanded, and a generator. The device further comprises a fluidly separate burner circuit with a burner for providing hot combustion gases which circuit is connected with the at least one heat exchanger, and which parts are arranged in a way known per se and where the turbine during operation powers the compressor and the generator. The generator supplies electrical energy to a domestic or local electrical system and/or powers auxiliary devices of the heating device, and at least a part of the air of the working flow leaving the turbine and/or at least a part of the combustion gases of the burner flow are/is used for heating a building or a process.

### TECHNICAL FIELD

The present invention relates to a heating device suitable for domestic and other small scale heating purposes, which device also generates electricity. The device thus has a very high total efficiency as well as high reliability.

### BACKGROUND OF THE INVENTION

The price of electricity is increasing steadily. This is because the cost of fossil fuels is increasing since it is a resource with limited availability. It is therefore important to produce electricity with the highest possible efficiency.

One way of achieving this is to use combined heat and power generation, which today mainly is used for larger industrial applications. The electricity can be used locally and/or exported to a power grid.

Currently, there are no systems that are suitable for the corresponding type of electricity generation in the very small scale, for example in domestic applications. There are today small piston-engine based generator sets that recover the heat losses in the cooling water and in the exhaust and convert it to useful heat. There is also active development work being carried out on small Stirling engines and fuel cells for similar applications. Important characteristics are—very low cost, very little maintenance, and very little negative influence on the environment. None of the above technologies can today achieve all of these characteristics.

### SUMMARY OF THE INVENTION

The objects of the present invention are achieved by a heating device comprising at least one heat exchanger, which is closely integrated with a burner, and a high-speed shaft on which a generator, a compressor and a turbine is mounted. There are two fluidly separate streams of flow, where one is directed through the burner and is called burner flow. This flow is at a pressure close to atmospheric pressure making it possible to use a burner of the same type that is used in a conventional boiler. The other flow is called working flow and this enters the compressor.

In a first embodiment of this invention, the burner flow passes at least one of the heat exchangers. Heat from the burner flow is there transferred to the working flow, which passes the other side of the same heat exchanger. The heated working flow is then expanded through the turbine, which drives the compressor and the generator. The working flow is then connected to a water heat exchanger in such away that all or part of the working flow can transfer heat to the water that passes on the other side. This heated water can then be used for heating a building or be used in a process. The hot working flow can also be used for directly heating a building. The hot combustion gases can also be led through a heat exchanger for heating water or air for a building, or it can directly heat a process.

The system also contains power electronics that converts the high frequency electricity generated in the generator to conditions that fit the load. Depending on the exact application and its requirements there are also valves in the system, which e.g. allow a good control of the amount of useful heat as well as electricity that is generated by the system, and also makes it possible to control the combustion in the burner.

The high-speed shaft is preferably supported by either air bearings or electromagnetic bearings to allow very little maintenance and to minimize the use of oil in the system.

### BRIEF DESCRIPTION OF THE DRAWINGS

The present invention will be more readily understood by looking at the appended figure, in which

FIG. 1 is a schematical view of an embodiment of a heating device with integrated electricity generation.

### DETAILED DESCRIPTION OF A PREFERRED EMBODIMENT

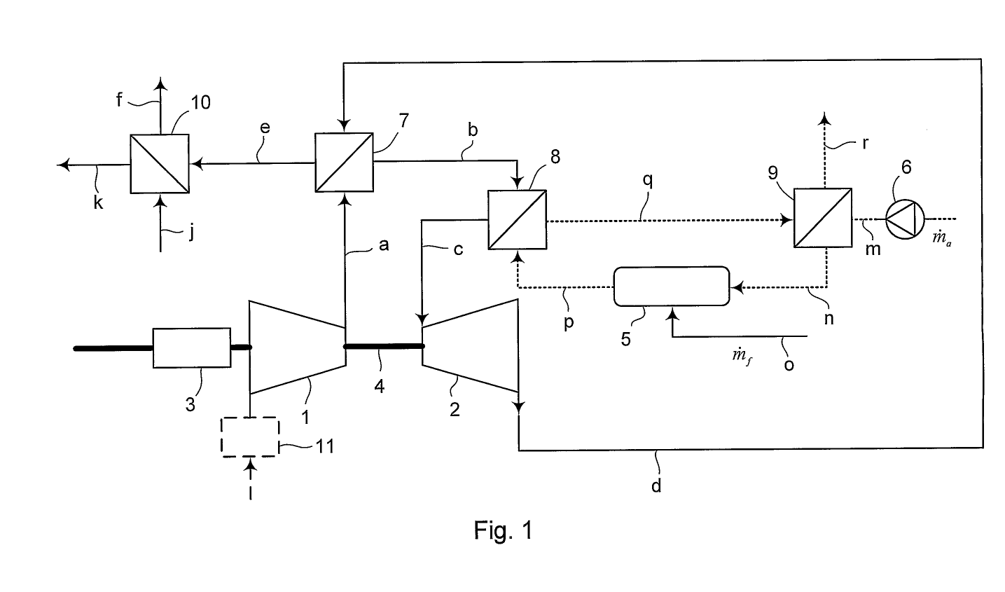

The heating device with electricity generation of the present invention utilises the open Brayton cycle and is built around a compressor 1 and a turbine 2, which are interconnected by a main shaft 4, see FIG. 1. Both the compressor 1 and the turbine 2 are preferably supported by air bearings or electromagnetic bearings in order not to contaminate the air flowing through the device. A generator 3 is also mounted on the main shaft 4. The device further comprises a burner 5 for combustion of a suitable air and fuel mixture, where a controllable fan 6 supplies the air. At least one heat exchanger 7, 8, 9, 10 is associated with the device for transferring heat from the combustion in the burner 5 to the air that passes the turbine 2, for retrieving heat Q from the hot working flow after the turbine 2 e.g. for heating a building or a process and for preheating the air entering the burner 2.

In order to explain the operation of the device, a thorough description will be given below, in which letters a-f, j, k, m-r designate various pipes of the device. The chosen starting point is the inlet to the compressor 1.

Fresh air enters the compressor 1 through an optional air filter 11. The air leaves the compressor 1 at an elevated pressure and temperature and proceeds along pipe a to a heat exchanger 7 where it may be additionally heated by hot air, see below. The hot air leaves the heat exchanger 7 through pipe b and enters a second heat exchanger 8. This heat exchanger 8 is heated by the gases that emanate from the combustion in the burner 5, see below. The air is now heated to a temperature of about at least 750° C. and is fed through pipe c to the turbine 2, where some of the heat is converted into mechanical energy. This energy is used partly to drive the compressor 1 and partly to drive the generator 3 for generating electricity. The air leaves the turbine 2 and is brought through pipe d to the first heat exchanger 7, where some of the remaining heat may be transferred to air that has left the compressor 1, see above. The working air is then brought through an optional second heat exchanger 10, which may be coupled to a hot-water system or a water-heating system. The air leaving the device does not contain any combustion gases and cannot be polluted by oil from any bearings, and it can thus be used directly for heating a building or process with the heat that remains after it has passed the optional heat exchanger 10.

In order to provide heat from combustion, air is supplied by the fan 6, or through natural ventilation, through a pipe m in a fluidly separate burner circuit. The combustion air may be preheated by the heat exchanger 9, and the air is then brought to the burner 5 through a pipe n. Fuel is supplied through a pipe o, and is mixed and combusted in the burner 5. The combustion gases are brought through a pipe p to the heat exchanger 8, where heat is transferred to the working flow, see above. The combustion gases are then led through a pipe q to the optional heat exchanger 9, where heat from the combustion gases may be used to preheat the air bound for the burner 5, as mentioned above. The combustion gases are finally led through a pipe r to the outside of the gas turbine system, preferably through a chimney (not shown) located remote from the inlet of the compressor 1. The combustion gases can also be used for heating a building or process, instead of or together with the airflow leaving the turbine 2.

Some of the combustion gases can be supplied to the burner, either before or after the optional heat exchanger 9. The heat from the combustion gases can also be used for heating water of a hot-water or water-heating system (not shown) in the heat exchanger 10, which water can be used for heating a building or a process.

The heat exchanger 8, fluidly arranged between the compressor 1 and turbine 2 and being connected to the burner circuit, may by-passed on either the burner side or on the compressor/turbine side, in order to regulate the electric output from the generator 4. At least a part of the air of the working flow leaving the turbine 2 may be supplied to the burner 5. This can be controlled by a valve (not shown) e.g. between pipes d and n or d and m. At least a part of the air of the working flow may be taken before the water heat exchanger 10 and be used directly for heating the building or the process.

The rotational speed of the shaft 4 may be controlled by the electrical load of the generator 3. The high-speed shaft 4 may always rotate at least at idle speed to allow a fast start of power generation.

The fuel consumption may be changed to control the total amount of energy that is generated by the system. A battery or capacitor may be used for storing energy during normal operation of the heating device and for supplying energy to the heating device when the power grid is down, for providing a black start capability.

The air of the working flow and the combustion gases of the burner flow may be arranged in such a way that high pressure air of the working flow substantially surround the pipes and systems that contain combustion gases. A valve (not shown) may be provided at the inlet to the compressor 1 for controlling the flow rate and pressure of the air of the working flow.

The generator 3 may also operate as a motor in order to make the compressor 1 run during start-up of the system. The system is self-propelled once the combustion is delivering enough energy through the heat exchanger 8 to obtain positive work from the turbine-compressor assembly.

The above device has a conversion efficiency of about 23%, i.e. the conversion of heat to electricity. Energy in the form of heated water and air also leaves the system, and the overall efficiency is about 80%.

Even though the device according to the present invention is given as a detailed example, it will be evident to a person skilled in the art that several modifications can be made without departing from the scope of the appended claims. The fuel can e.g. be any suitable fuel, such as natural gas, diesel, fuel oil (domestic oil), gasoline, kerosene, methane, ethane, carbon monoxide, bio-fuel in any form, such as grain, wheat, barley, wood pellets, wood meal etc.

Whenever a reference is made to a building or process, it is intended to be a generic building or process.

1. A heating device for generating heat and electricity comprising: a compressor, at least one heat exchanger for heating air of a working flow leaving the compressor, a turbine where the heated air of the working flow is expanded, a generator, a fluidly separate burner circuit with a burner for providing hot combustion gases which circuit is connected with the at least one heat exchanger, and which parts are arranged in a way known per se and where the turbine during operation powers the compressor and the generator, and the generator supplies electrical energy to a domestic or local electrical system and/or powers auxiliary devices of the heating device, and at least a part of the air of the working flow leaving the turbine and/or at least a part of the combustion gases of the burner flow are/is used for heating a building or a process.

2. A heating device according to claim 1, wherein at least a part of the combustion gases of the burner flow is recirculated to the burner.

3. A heating device according to claim 1, wherein a part of the combustion gases of the burner flow is supplied to a heat exchanger for heating therein circulated water of a water-heating system or a hot water system.

4. A heating device according to claim 1, wherein the heat exchanger, fluidly arranged between the compressor and turbine and being connected to the burner circuit, is by-passed on either the burner side or on the compressor/turbine side, in order to regulate the electric output from the generator.

5. A heating device according to claim 1, wherein at least a part of the air of the working flow leaving the turbine is supplied to the burner.

6. A heating device according to claim 1, wherein at least a part of the air of the working flow is taken before the water heat exchanger and is used directly for heating the building or the process.

7. A heating device according to claim 1, wherein the rotational speed of the shaft is controlled by the electrical load of the generator.

8. A heating device according to claim 1, wherein the high-speed shaft always rotates at least at idle speed to allow a fast start of power generation.

9. A heating device according to claim 1, wherein the fuel consumption is changed to control the total amount of energy that is generated by the system.

10. A heating device according to claim 1, wherein a battery or capacitor stores energy during normal operation of the heating device and supplies energy to the heating device when the power grid is down, for providing a black start capability.

11. A heating device according to claim 1, wherein the air of the working flow and the combustion gases of the burner flow are arranged in such a way that high pressure air of the working flow substantially surround the pipes and systems that contain combustion gases.

12. A heating device according to claim 1, wherein a valve is provided at the inlet to the compressor for controlling the flow rate and pressure of the air of the working flow.
